(19) United States
(12) Patent Application Publication
(10) Pub. No.: US 2005/0109093 A1
(43) Pub. Date: May 26, 2005

(54) System and method for detecting low tire pressure

(75) Inventors: Carlos Efrain Martinez Marrufo, Guadalajara (MX); Victor Rodrigo Jauregui Sandoval, Zapopan (MX); Jorge Antonio Vazquez Murillo, Zapopan Jalisco (MX); Gerardo Echeagaray Camacho, Tlaquepaque Jalisco (MX)

Correspondence Address: SIEMENS CORPORATION;INTELLECTUAL PROPERTY LAW DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 10/994,164

(22) Filed: Nov. 19, 2004

Related U.S. Application Data
(60) Provisional application No. 60/524,154, filed on Nov. 21, 2003.

(51) Int. Cl. G01M 17/02

(52) U.S. Cl. 73/146

(57) ABSTRACT

A tire pressure monitoring system and method detects a low tire pressure condition based on an angular velocity of a wheel. When a tire is under-inflated, the radius of the tire decreases, causing the angular velocity of the wheel associated with that tire to increase. Because the angular velocity is correlated with the tire pressure, the angular velocity may be compared with a threshold to determine if the tire pressure is below a desired level.

### REFERENCE TO RELATED APPLICATIONS

The present invention claims the benefit of U.S. Provisional Patent Application No. 60/524,154, filed Nov. 21, 2004.

### TECHNICAL FIELD

The present invention relates to tire pressure monitoring system, and more particularly to a method and system for detecting low tire pressure.

### BACKGROUND OF THE INVENTION

Vehicles often incorporate tire pressure monitoring systems to alert the user when the pressure in one or more of the tires falls below a desired level. These pressure monitoring systems make it more convenient for the user to detect when a tire is in a low pressure condition because the user no longer needs to remember to check tire pressure manually. Currently-known systems include tire pressure sensors that are associated with each tire.

To provide the tire pressure information to the user, however, the monitoring system must include extra hardware and calibration processes to enable the user to correlate a given sensor with a particular tire position. For example, additional hardware may be placed in the chassis near each tire to allow the sensor to transmit its pressure information to a central module via a low frequency interface. The central module detects the tire position when it receives the tire pressure information by controlling the additional hardware. The additional devices trigger the tire pressure sensor by a low range, low frequency RF signal. Thus, the central module is able to command a particular sensor associated with a given position to transmit information.

A unique identification code may be assigned to each tire during a calibration process so that the central module can identify the position of a given tire. If the calibration is conducted manually by the vehicle manufacturer or dealer, no additional hardware is needed. However, the central module must be recalibrated each time the tire positions change (e.g., during rotation) or if a tire is changed, requiring the user to return to the dealer to conduct the recalibration.

Another proposed system includes mounting four receiver antennas, one antenna for each tire, close to each wheel so that the power of the signal generated by one of the sensors is filtered. However, this approach also requires extra hardware for multiplexing the input of the antennas to the central module.

There is a desire for a tire pressure monitoring system and method that can detect a tire pressure sensor position without extra hardware or calibration.

### SUMMARY OF THE INVENTION

The invention is directed to a tire pressure monitoring system and method that detects a low tire pressure condition based on an angular velocity of a wheel. When a tire is under-inflated, the radius of the tire decreases, causing the angular velocity of the wheel associated with that tire to increase. Because the angular velocity is correlated with the tire pressure, the angular velocity may be compared with a threshold to determine if the tire pressure is below a desired level. A processor in a central module may correlate the angular velocity with the tire pressure.

By using angular velocity to infer tire pressure, there is no need for separate tire pressure sensors in the system. The system may instead use angular velocity data from existing sensors for tire pressure detection.

A system that already contains an RF tire pressure sensor may use the information provided by other systems in the car, for example an ABS system, to identify the location of the wheel with low pressure.

### BRIEF DESCRIPTION OF THE DRAWINGS

FIG. 1 is a diagram illustrating underlying concepts used by one embodiment of the invention;

FIG. 2 is a block diagram representing components in a tire pressure monitoring system according to one embodiment of the invention;

FIG. 3 is a flow diagram illustrating a method used by the tire pressure monitoring system according to one embodiment of the invention.

### DETAILED DESCRIPTION OF THE PREFERRED EMBODIMENT

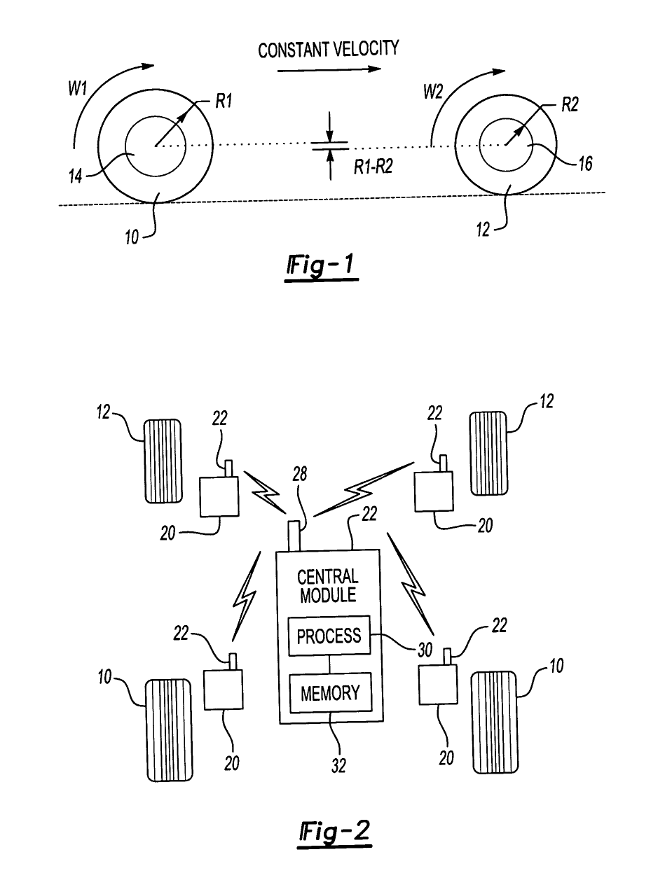

FIG. 1 is a schematic diagram that illustrates the concepts used by the invention to detect low tire pressure according to one embodiment of the invention. In this illustration, it is assumed that a rear tire 10 is inflated to a proper pressure and a front tire 12 has low pressure. The rear and front tires 10, 12 in a vehicle are rotatable about rear and front wheels 14, 16, respectively. Because the front tire 12 has a lower pressure, the radius of the front tire 12 has a smaller radius R2 than the radius R1 of the properly inflated rear tire 10.

The linear velocity of a given wheel 14, 16 will always be known because it corresponds to the speed of the vehicle. The linear velocity of the rear wheel 14 and the front wheel 16 will always be the same. However, because the radii R1 and R2 are different due to the different tire pressures, the angular velocity ω of the front wheel 16 and front tire 10 will be greater than the angular velocity of the rear wheel 14 and rear tire 10. More particularly, because w)=v/r, where is the linear velocity and r is the radius, the smaller radius R2 of the front tire 12 will cause the front wheel 16 to rotate faster than the rear wheel 14.

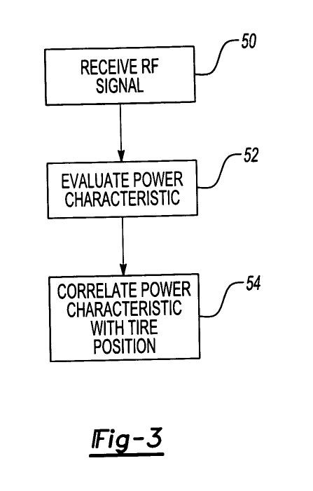

Referring to FIG. 2, each tire 10, 12 has an associated sensor 20 that measures the tire pressure of the tire and transmits an RF signal indicating the tire pressure of its corresponding tire 10, 12 to a central module 22 via an associated antenna 24. Note that the sensor 20 may already exist in. In one embodiment, the sensor 20 is a device that generates an RF signal output. The central module 22 itself has a receiver 28 that receives the signals from the sensors 20 and a processor 30 that evaluates the sensor signals.

If all of the tires 10, 12 are properly inflated to equal pressures, each sensor 20 will output the same RF signal because each wheel 14, 16 will have the same angular velocity. If one or more of the tires 10, 12 is under-inflated (e.g., the front tire 12 in FIG. 1), however, the reduced radius of the under-inflated tire 12 will cause the under-inflated tire 12 to rotate faster than the other tires. The sensor 20 associated with the under-inflated tire will therefore output an RF signal indicating the tire pressure has decreased to the receiver 28 of the central module 22.

The processor 30 may run a data correlation algorithm that correlates the angular speed of each tire with a specific tire pressure via, for example, a look-up table containing empirically-derived data and/or functions linking the angular speed and tire pressure. The processor 30 may also compare the angular velocity of each wheel with a maximum threshold corresponding to a minimum desirable tire pressure. Alternatively, or in addition, the processor 20 compares the angular velocities of each tire 10, 12 to detect if one of the tires has a faster angular velocity than the other three tires.

By comparing the angular velocities of the tires, either with each other or with a threshold, the central module 22 can detect whether any of the tire has a pressure drop that is sufficient to change the radius of the tire and therefore the angular velocity of its corresponding wheel. The algorithm may take into account other factors, such as tire friction, vehicle turning and braking, etc.) in determining whether a given angular velocity indicates an undesirably low tire pressure.

Detecting the existence of a low pressure tire is insufficient without a way to identify the position of the tire. To do this without the inconvenience of currently known tire position/identification systems, the central module 22 will request the information of the tire angular speed from a separate system, such as an ABS system (not shown). This system can provide the angular velocity of each wheel together with the location of each tire, thus identifying the tire that has increased the angular velocity, we can find the location of the low pressure tire.

The receiver 28 of the central module 22 is positioned such that the power characteristic of the RF signal transmitted by each antenna 24 will be different. More particularly, the position of each antenna 24 will affect the power characteristic of the RF signal from that antenna 24 based on its distance from the receiver 28. The distance between a given antenna 24 and its associated sensor 20 will also influence the power characteristic of the RF signal from that antenna 24.

Because the antennas 24 are at different distances and positions relative to the receiver 28, the processor 30 can correlate a given power characteristic with a given tire position. Each antenna 24 will output an RF signal having a different power characteristic even when the RF signals for each tire are the same (i.e., if all four tires have the same angular velocities). Note that the power characteristics are based on the positions of the tires 10, 12 and not the specific tire itself. Thus, if one of the RF signals indicates an angular velocity that is higher than a desired threshold (indicating low tire pressure), it is possible to identify which tire has low tire pressure by simply checking the power characteristic of the RF signal and correlating that power characteristic with the tire position.

As shown in FIG. 3, the processor 30 receives the RF signal from at least one of the sensors 20 via its associated antenna 24 (block 50) and evaluating the power characteristic of the signal (block 52). In one embodiment, the processor 30 compares the power characteristic of the signal with at least one reference power characteristic. The central module 22 may include a memory 32 that stores four reference power characteristics, one for each tire position in the vehicle (FIG. 2). The processor 30 can therefore correlate the power characteristic of the RF signal it receives with the position of the tire 10, 12 associated with the signal (block 54), without any tire identification information.

If the tires are changed or rotated, there is no need for a recalibration because the correlation between the tire pressure and the angular velocity can be detected in any of the four possible locations; the power characteristic of the RF signal does not depend on the characteristics of the tire itself. Instead, the power characteristic depends only on the position of the antenna 24 relative to the sensor 22 and to the receiver 28. By using the correlation between the tire pressure RF signal sent to the central module and angular velocity to determine tire position, the invention eliminates the need to include extra hardware for transmitting tire location information and also eliminates extra tire identification calibration steps during the manufacturing process and updates during tire position changes.

It should be understood that various alternatives to the embodiments of the invention described herein may be employed in practicing the invention. It is intended that the following claims define the scope of the invention and that the method and apparatus within the scope of these claims and their equivalents be covered thereby.

1. A tire pressure monitoring system for a vehicle, comprising:
at least one sensor that detects an angular velocity of at least one tire and transmits a signal corresponding to the angular velocity;
a receiver that receives the signal; and
a processor that evaluates the signal and indicates a low tire pressure condition based on the signal.

2. The system of claim 1, wherein the processor indicates the low tire pressure condition if the signal indicates that the angular velocity is above a selected threshold.

3. The system of claim 1, wherein said at least one sensor includes a plurality of sensors, and wherein the processor evaluates the signal by comparing the angular velocity corresponding to one of said plurality of sensors with the angular velocity corresponding to another of said plurality of sensors.

4. The system of claim 3, wherein the vehicle has four tires, wherein each of said plurality of sensors corresponds with one of said four tires, and wherein the processor indicates the low pressure tire condition if the signal from one of said plurality of sensors indicates that the angular velocity of one of said tires is higher than the angular velocity of the other of said tires.

5. The system of claim 1, further comprising a memory containing data correlating angular velocity with tire pressure, wherein the processor is in communication with the memory.

6. A method for monitoring tire pressure, comprising:
detecting an angular velocity of at least one tire; and
evaluating the angular velocity to detect a low tire pressure condition.

7. The method of claim 6, wherein the evaluating step indicates the low tire pressure condition when the angular velocity is above a selected threshold.

8. The method of claim 6, wherein the detecting step comprises detecting the angular velocities of a plurality of tires, and wherein the evaluating step comprises indicating the low pressure condition if one of said plurality of angular velocities is higher than another of said plurality of angular velocities.

9. The method of claim 6, further comprising correlating the angular velocity with a tire pressure value.

10. The method of claim 6, wherein the evaluating step includes locating the low anomalous pressure tire based on location of the angular velocity tire information requested from the additional system.

11. The method of claim 6, wherein the evaluating step comprises detecting the angular velocities of a plurality of tires, and wherein the evaluating step comprises indicating the location of the anomalous pressure tire if one of said plurality of angular velocities is different than another of said plurality of angular velocities.

12. The method of claim 6, further comprising correlating the angular velocity with a tire pressure value.

13. A method for identifying a tire location, comprising:
detecting an anomalous tire pressure of at least one tire; and
evaluating angular velocity information requested from an additional system to detect the location of the anomalous pressure tire.
